(19) United States
(12) Patent Application Publication
(10) Pub. No.: US 2016/0005528 A1
(43) Pub. Date: Jan. 7, 2016

(54) HIGH PERFORMANCE HIGH CURRENT POWER INDUCTOR

(71) Applicant: COOPER TECHNOLOGIES COMPANY

(72) Inventors: Yipeng Yan, Shanghai (CN); Robert James Bogert, Lake Worth, FL (US); Brent Elliot, El Dorado Hills, CA (US); Guo Ouyang, Guangdong (CN)

(21) Appl. No.: 14/854,822

(22) Filed: Sep. 15, 2015

Related U.S. Application Data
(63) Continuation of application No. PCT/US2014/013116, filed on Jan. 27, 2014.

(30) Foreign Application Priority Data
Mar. 15, 2013 (CN) 201310177815.2

(51) Int. Cl. H01F 27/29

(52) U.S. Cl. CPC H01F 27/292

(57) ABSTRACT

An electromagnet component assembly includes a preformed conductive winding formed in at least first and second pieces for assembly with a single magnetic core with a simplified and relatively low cost manufacture. The assembly provides a power inductor operable at higher current, higher power levels with reduced direct current resistance.

### CROSS REFERENCE TO RELATED APPLICATIONS

This application is a continuation application of International Application No. PCT/US2014/013116.

### BACKGROUND OF THE INVENTION

The field of the invention relates generally to the construction and fabrication of miniaturized magnetic components for circuit board applications, and more specifically to the construction and fabrication of miniaturized magnetic components such as power inductors.

Power inductors are used in power supply management applications and power management circuitry on circuit boards for powering a host of electronic devices, including but not necessarily limited to hand held electronic devices. Power inductors are designed to induce magnetic fields via current flowing through one or more conductive windings, and store energy via the generation of magnetic fields in magnetic cores associated with the windings. Power inductors also return the stored energy to the associated electrical circuit as the current through the winding falls and may provide regulated power from rapidly switching power supplies.

In order to meet increasing demand for electronic devices, especially hand held devices, each generation of electronic devices need to be not only smaller, but offer increased functional features and capabilities. As a result, the electronic devices tend to be increasingly powerful devices in smaller and smaller physical packages. Meeting increased power demands of ever more powerful electronic devices while continuing to reduce the size of circuit boards and components such as power inductors that are already quite small, has however, proven challenging.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a perspective view of a first exemplary embodiment of a surface mount power inductor for a circuit board application.

FIG. 2 is side perspective view of the magnetic core for the power inductor shown in FIG. 1.

FIG. 3 is an end perspective view of the magnetic core shown in FIG. 2.

FIG. 4 is a perspective view of a first preformed portion of the conductive winding for the power inductor shown in FIG. 1.

FIG. 5 is a perspective view of the magnetic core shown in FIGS. 2 and 3 with the portion of the conductive winding shown in FIG. 4 assembled thereto.

FIG. 6 is a perspective view of the assembly shown in FIG. 5 from the opposite side.

FIG. 7 is a perspective view of an exemplary preformed terminal portion for the power inductor shown in FIG. 1.

FIG. 8 is an end perspective shown of the magnetic component shown in FIG. 1 with the preformed terminal portion installed.

FIG. 9 is a perspective view of a preformed terminal portion assembly for fabricating a second exemplary embodiment of a surface mount power inductor for a circuit board application.

FIG. 10 shows the preformed terminal portion assembly of FIG. 9 with magnetic cores assembled therewith.

FIG. 11 shows a preformed conductive main winding portion of a conductive winding for the second exemplary embodiment of a power inductor.

FIG. 12 shows the preformed conductive main winding portion of FIG. 11 being installed to one of the magnetic cores shown in FIG. 10.

FIG. 13 shows the preformed conductive main winding portion of FIG. 11 installed to all of the magnetic cores shown in FIG. 10, thereby providing a plurality of discrete power inductors each having a single conductive winding.

FIG. 14 is a perspective view of a third exemplary embodiment of a surface mount power inductor for a circuit board.

FIG. 15 shows a preformed terminal portion assembly for fabricating the third exemplary embodiment of a power inductor shown in FIG. 14.

FIG. 16 illustrates magnetic cores assembled to the preformed terminal portion assembly and conductive main winding portions installed, thereby providing a plurality of discrete power inductors each having a pair conductive windings.

FIG. 17 is a perspective view of a fourth exemplary embodiment of a surface mount power inductor for a circuit board application.

FIG. 18 shows a preformed terminal portion assembly for fabricating the fourth exemplary embodiment of a surface mount power inductor.

FIG. 19 illustrates magnetic cores assembled to the preformed terminal portion assembly and conductive main winding portions installed, thereby providing a plurality of discrete power inductors each having three conductive windings.

FIG. 20 is a perspective view of a magnetic core for a fifth exemplary embodiment of a surface mount power inductor for a circuit board application.

FIG. 21 is an end perspective view of the assembly shown in FIG. 21.

FIG. 22 shows a preformed terminal portion assembly for fabricating the fifth exemplary embodiment of a power inductor shown in FIG. 21.

FIG. 23 shows the preformed terminal portion assembly of FIG. 22 with magnetic cores as shown in FIGS. 20 and 21 assembled therewith.

FIG. 24 shows a preformed conductive main winding portion of a conductive winding for the fifth exemplary embodiment of a power inductor.

FIG. 25 shows the preformed conductive main winding portion of FIG. 24 being installed to one of the magnetic cores shown in FIG. 25.

FIG. 26 shows the preformed conductive main winding portion of FIG. 24 installed to all of the magnetic cores shown in FIG. 25, thereby providing a plurality of discrete power inductors each having a single conductive winding.

### DETAILED DESCRIPTION OF THE INVENTION

In order to provide increasingly powerful electronic devices having an ever expanding number of features and capabilities, the power inductors used in the power management circuitry in general must operate at higher levels of current and power as the devices operate. Known techniques to manufacture miniaturized power inductors for circuit board applications are, however, problematic for higher current applications.

In order to provide smaller power inductor components for circuit boards, the conductive windings and the magnetic cores have each conventionally become much smaller in physical size. At lower operating currents the smaller windings present no particular problems from a performance perspective and such arrangements may work quite well. For higher current, higher power applications, however, the reduced size of the conductive windings is actually counterproductive. Because of the small conductors used to fabricate miniature windings, the small cross sectional area through which current must flow in the winding results in increased direct current resistance (DCR) of the completed power inductor. In high current, high power applications a conventional miniature winding may therefore possess an unacceptably high DCR that corresponds to significant power losses in the power management circuitry. Increasing the cross sectional area of the windings can reduce DCR of the power inductor component, but this presents other problems from a manufacturing perspective.

Specifically, laminated power inductor products are known having a number of magnetic layers or substrates upon which planar portions of a conductive winding may be formed. When the planar winding portions of the various layers are connected with one another, a larger conductive coil is completed amongst the various layers in the device. Forming fine conductive windings on the surfaces of magnetic substrates and the like using printing techniques, deposition techniques, or lithography techniques can successfully provide extremely small components. However, such windings formed by such techniques are quite limited in their ability to function at high current, high power levels at all, nor do they provide relatively large cross sectional areas of the windings required to reduce DCR to acceptable levels for high current, high power applications.

In lieu of forming conductive windings on the surfaces of magnetic substrates and the like, shaped magnetic cores are sometimes used in combination with separately fabricated, freestanding conductor elements that are shaped or bent into the final form of a conductive winding as the power inductor is manufactured. In many instances, such freestanding conductor elements are shaped or bent around one or more surfaces of the magnetic core pieces utilized. Specifically, the one or both ends of the conductor is typically bent around opposing side edges of the magnetic core to form surface mount terminals for the power inductor to be terminated to corresponding circuit mount pads on a circuit board.

Because the shaped magnetic core pieces are relatively small, however, they are also relatively fragile, and bending or shaping the freestanding conductor around the core piece can be problematic if the magnetic core piece or the conductor is damaged during manufacture of the component. Of course, increasing the cross sectional area of the conductor utilized to fabricate the winding results in a stiffer conductor that is more difficult to bend, and hence only increases the difficulty of manufacturing power inductors without cracking or otherwise damaging the magnetic core pieces. Damage to the core pieces, which may be difficult to control or detect, can lead to considerable performance fluctuation in the manufactured power inductors that is inherently undesirable. Still further, stiffer conductor elements present difficulties in providing completely flat surface mount terminals when bending the conductor around the core. If the surface mount terminals are not flat, the mechanical and electrical connections when the device is mounted to a circuit board is likely to be compromised.

More recently, it has been proposed to use so-called preformed conductive windings that are separately fabricated from magnetic cores and are shaped entirely shaped in advance to include the surface mount terminal pads needed to connect the winding to a circuit board. Such preformed conductive windings may have a C-shaped clip configuration that may be slidingly assembled to magnetic core pieces without bending or shaping any portion of the winding over the magnetic core pieces utilized.

While such preformed windings avoids damaging the magnetic cores as the components are manufactured, as well as easily provides flat terminal pads, they too have certain drawbacks form a manufacturing perspective. For example, the preformed windings generally require at least two core pieces having different shapes to be used for each power inductor component manufactured. The preformed winding is first assembled to a first magnetic core piece, and a second core piece is then assembled with the first core piece to embed the winding between the two magnetic core pieces. While the preformed coils in such components may be provided with increased cross sectional areas to reduce DCR of the power inductor in use, this would tend to further complicate the shapes of the magnetic core pieces required to manufacture the power inductors. Such preformed windings and multiple core pieces results in a cumbersome assembly process that is relatively difficult to automate in some aspects.

A simpler and more economical power inductor manufacture is desired to provide surface mount power inductor components that may operate at higher currents with reduced DCR. Accordingly, exemplary embodiments of surface mount power inductor components are described below that achieve lower DCR values in use, while more effectively utilizing automated manufacturing techniques, reducing the costs of manufacture, and enhancing the reliability of the manufactured power inductors. Method aspects will be in part apparent and in part explicitly discussed in the following description in which the benefits and advantages of the inventive concepts will be demonstrated.

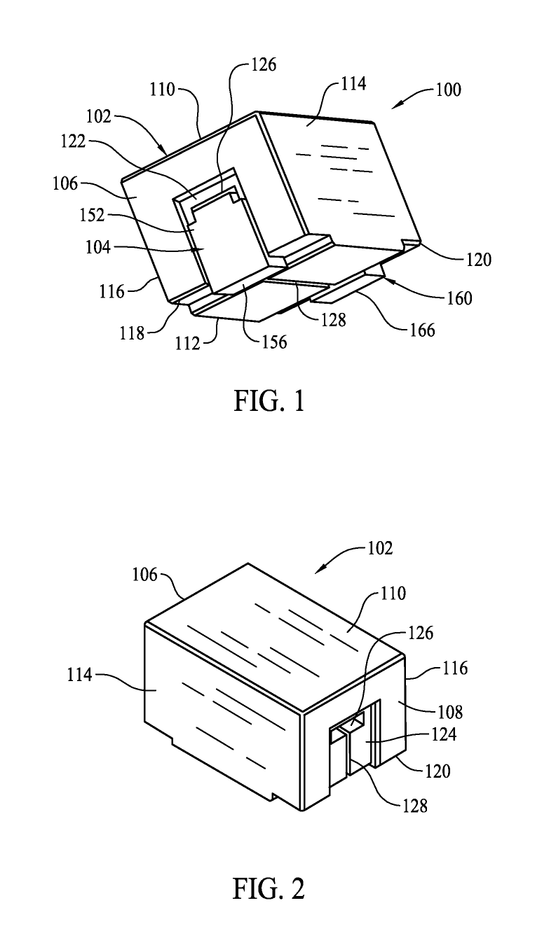

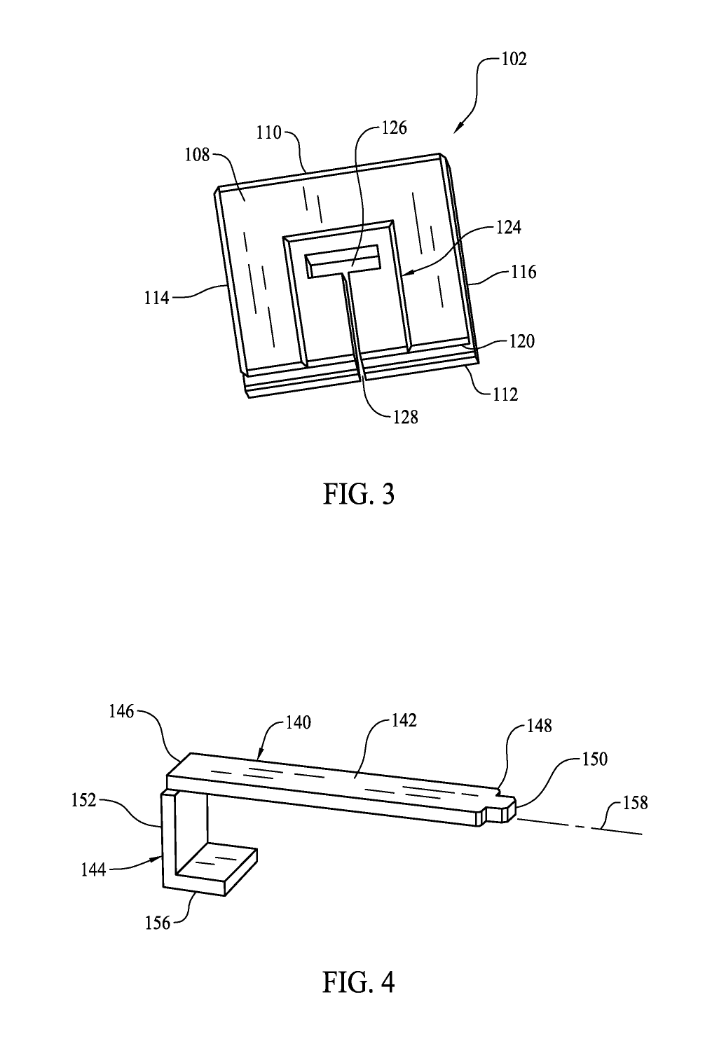

FIG. 1 illustrates a first exemplary embodiment of an electromagnetic component assembly 100 in the form of a power inductor. The assembly 100 includes a magnetic core 102 (also shown in FIGS. 2 and 3) and a conductive winding 104 fabricated from at least two preformed portions as described further below.

Referring to FIGS. 1-3 the magnetic core 102 in the exemplary embodiment depicted is generally rectangular in shape and includes opposed end edges 106 and 108, opposed top and bottom surfaces 110 and 112 extending between the end edges 106 and 108, and opposed lateral or side edges 114 and 116 interconnecting the edges 106 and 108 and the top and bottom surfaces 110 and 112.

The bottom surface 112 of the magnetic core 102 further includes a first recess 118 adjacent the end edge 106 and a second recess 120 adjacent the end edge 108. The recesses 118 and 120 allow surface mount terminal pads (described below but indicated by reference elements 156, 166 In FIG. 1) of the conductive winding 104 to be flush mounted with the bottom surface 112 of the power inductor. That is, the recesses 118 and 120 provide a clearance near each end edge 106 and 108 to accommodate a relatively thick surface mount terminal pad, with the bottom of the surface mount pads near each edge 106, 108 being flush with a non-recessed external surface of the bottom surface extending between the two recesses 118, 120. Similarly, the end edges 106, 108 in the exemplary embodiment shown also include recesses 122, 124 that accommodate relatively thick portions of the conductive winding extending along the end edges 106, 108 with the external surface of the winding being substantially flush with the exterior surface of the end edges 106, 108. The recesses 118, 120, 122, 124 provide for a compact configuration of the completed power inductor component 100 by nesting the thick winding within the confines of the magnetic body 102 such that the exposed portions of the winding 104 do not protrude from the core 102.

As also seen in FIGS. 1-3 the magnetic core 102 includes a longitudinal through-hole opening 126 extending completely through the core 102 from the end edge 106 to the end edge 108. The through-hole 126 shown in FIGS. 1-3 has an elongated rectangular cross section and the trough-hole 126 extends in a generally parallel relation to the top and bottom surfaces 110 and 112 of the magnetic core 102.

As also shown in FIGS. 1-3, the magnetic core 102 in the exemplary embodiment depicted includes a physical gap 128. The physical gap 128 extends from the bottom surface 112 to the lower portion of the through-hole 126. The physical gap 128 extends as an elongated slot that is in communication with the through-hole on its upper end, and is in communication with the bottom surface 112 on its lower end. The physical gap also extends to each of the recesses 122, 124 in the end edges 106, 108 of the core 102. In the embodiment shown, the gap 128 extends generally perpendicular to the bottom surface 112 and also the axis of the through-hole 126. In the example shown, the gap 128 substantially bisects the rectangular through-hole 126. The gap 128 and the through-hole 126 in combination therefore provide a T-shaped opening extending longitudinally through the core 102 from end edge 106 to end edge 108.

The through-hole provides a passage way for a portion of the winding 104, while the physical gap 128 provides for energy storage in the magnetic core 102 when the conductive winding 104 (FIG. 1) is connected to energized electrical circuitry on a circuit board and electrical current flows through the winding 104. The current flow through the winding induces a magnetic field in the core 102 which is stored as magnetic energy in the gap 128. When current falls or even ceases to flow through the winding, the magnetic energy stored in the core 102 induces current flow in the winding and the stored energy may be returned to the electrical circuitry.

The magnetic core 102 may be formed from a magnetic material known in the art and may be formed in a known manner, including but not limited to molding processes to impart the desired shape to the core 102. When distributed gap magnetic materials are utilized to form the core 102, the physical gap may be considered optional and may be omitted. In still further embodiments, however, the core 102 may both be fabricated from a distributed gap material as well as have the physical gap as shown. The power inductor 100 shown in FIG. 1 includes a single winding 104 in the core 102 such that the power inductor 100 is suitable for a single phase power management application, although it is recognized that more than one winding 104 may be provided as desired to manage, for example, two or three phase power applied to the inductor 100.

FIG. 4 illustrates a first preformed portion 140 of the conductive winding 102 (FIG. 1) for the power inductor 100. The first portion 140 includes a main winding portion 142 and a terminal portion 144. The main winding portion 142 is a generally planar conductive element fabricated from a conductive metal or conductive alloy known in the art. The main winding portion 142 in the embodiment shown is elongated and generally rectangular (i.e., has a rectangular cross section). The main winding portion 142 is generally uniform or constant in length, width, and height dimensions extending between first and second ends 146 and 148. The second end may include a tapered distal end 150 of reduced dimension to facilitate mechanical and electrical connection with another portion of the winding as described below. Further, the main winding portion 148 extends lineally (i.e., extends in a straight line along a single axis without any turns or bends) between the first and second ends 146, 148.

The terminal portion 144 includes a vertical winding section 152 in the depiction of FIG. 4 and a horizontal terminal pad 156. The winding section 152 connects to the end 146 of the main winding portion 142, and the terminal pad 156 extends from an opposing end of the winding section 152. The terminal pad 156 and the main winding portion 156 each extend substantially perpendicular to the winding section 152 but generally parallel to one another. In the example shown, the terminal portion 144 has a greater lateral width dimension, measured in a direction perpendicular to a longitudinal axis 158 of the main winding portion 142, than a corresponding width dimension of the main winding portion 142 itself. A thickness dimension, however, as measured between the opposing major surfaces of the main winding portion 142 and the terminal portion 144, is substantially equal in the main winding portion 142 and the terminal portion 144. The width and thickness values selected, in combination, provide an adequate cross sectional area of the winding that in turn reduces direct current resistance (DCR) of the power inductor 100 when used in a high current, high power application.

In contemplated embodiments the main winding portion 142 and the terminal portion 144 are separately fabricated from the core 102, and also are preformed and pre-assembled into a freestanding structure 140 that is assembled with the magnetic core 102 as further described below. In some embodiments, the main winding portion 142 and the terminal portion 144 may be integrally formed from a single piece of conductive material using known stamping and bending processes for example. In other embodiments, the terminal portion 142 may be preformed to include the surface mount pad 156, and the terminal portion 144 may be mechanically and electrically connected to the main winding portion 142 via welding techniques, for example, to provide the winding portion 140. Either way, at least the winding portion 140 is separately fabricated from the magnetic body 102 and provided for assembly therewith.

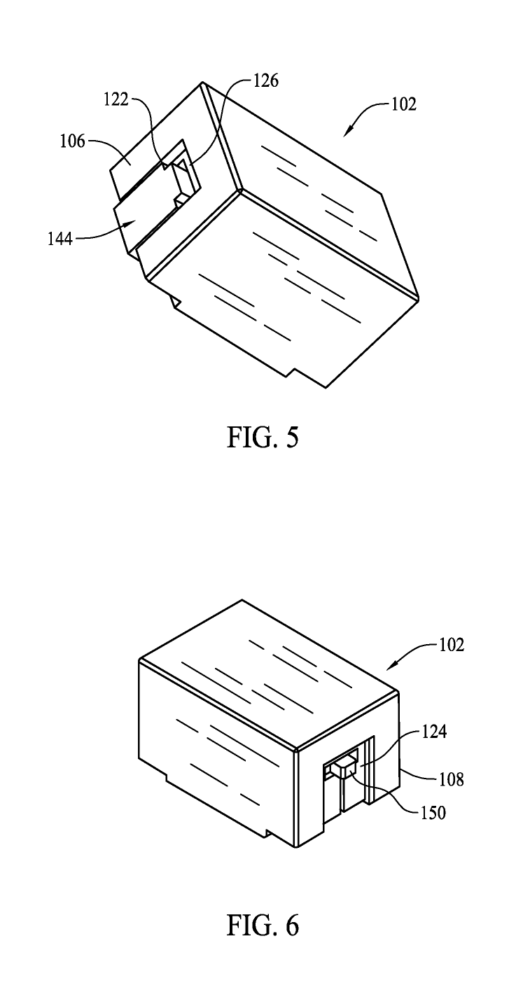

FIG. 5 shows the first portion 140 of the conductive winding 102 assembled to the magnetic core 102. The main winding portion 142 is extended through the through-hole 128 in the core 102 and the terminal portion 144 is located in the recess 122 in the core end edge 106. As seen in FIG. 6, the tapered end 160 of the main winding portion 142 extends through the through-hole on the other end edge 108 of the core 102.

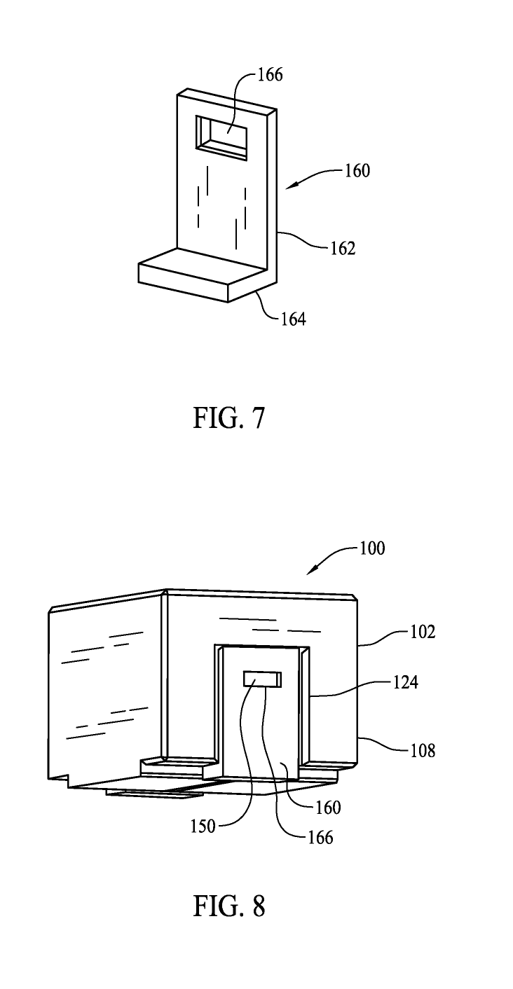

FIG. 7 shows a preformed terminal portion 160 that, in combination with the first terminal portion 140 (FIG. 4) completes the winding 102. Like the terminal portion 144, the terminal portion 160 includes a straight, vertically oriented winding section 162 and a horizontal surface mount terminal pad 164. The surface mount terminal pad 164 is preformed and separately fabricated from each of the core 102 and the winding portion 140. The terminal portion 160 is separately fabricated and provided for assembly with the winding portion 140 and the core 102. As shown in the example of FIG. 7, the upper end of the vertical winding section 162 includes an opening 166 that is dimensioned to receive the tapered end 150 of the winding portion 140. The terminal portion 164 is formed with the same width and thickness as the terminal portion 144 of the winding portion 140 (FIG. 4).

As shown in FIG. 8, the terminal portion 160 is assembled to the core 102 at the end edge 108. The winding section 162 fits in the recess 124 in the end edge 108 and the end 150 of the winding portion 140 (FIG. 4) is received in the terminal portion opening 166. The mating end 150 and the opening 166 may be mechanically and electrically connected via soldering or welding techniques to ensure mechanical and electrical connection between the winding portion 140 and the terminal portion 160. The terminal portion 160 and the winding portion 140, in combination, complete the conductive winding 104 (FIG. 1) extending through the magnetic core 102. The main winding portion 142 extends between the terminal portions 144, 160 including the terminal pads 156, 164. The terminal pads 156, 164 may in turn, be surface mounted to circuitry on a circuit board. The winding 104 that is completed in this exemplary embodiment is a C-shaped winding that completes less than one full turn about the magnetic core 102.

By virtue of the preformed winding construction in separate pieces 140 and 160, relatively thick conductor materials can be used to fabricate the winding without having to bend or shape the conductors around the core, and while eliminating any risk of damaging the core 102 in the process. Further, the surface mount pads 156, 164 are preformed into flat shapes in advance of assembly to the core 102. A power inductor having a greater cross sectional area in the winding, and offering a reduced DCR in use, is therefore possible using a single magnetic core 102 and relatively simple manufacturing steps that are more amendable to automation than other known types of power inductors having preformed windings. By virtue of the preformed winding 102 and simplified assembly to the core 102, highly reliable yet cost effective power inductors 100 are provided having uniform performance characteristics and that are capable of performing in higher current, higher power applications with reduced DCR.

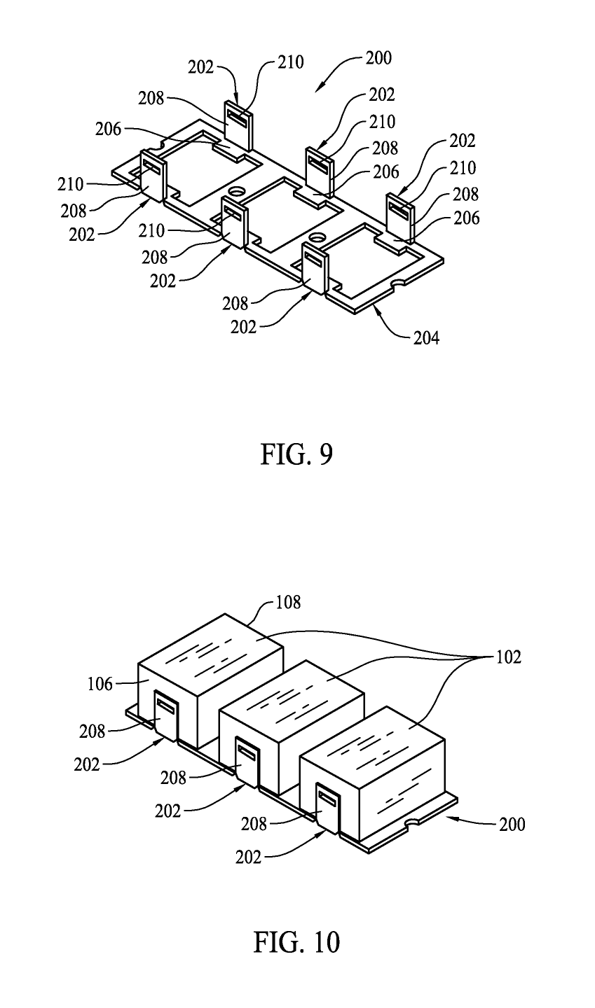

FIG. 9 illustrates a preformed terminal portion assembly 200 that may be used to fabricate power inductors according to a second embodiment. The preformed assembly 200 includes a series of pairs of terminal portions 202 arranged in opposing pairs and coupled to a lead frame 204. Each terminal portion 202 includes a preformed surface mount pad 206 and winding section 208 extending perpendicular to the surface mount pad 206 and out of the plane of the terminal lead frame 204. The winding sections 208 are each formed with an elongated rectangular opening 210. The terminal portion assembly 200 may be fabricated from known electrically conductive materials or alloys known in the art, and may be fabricated from a single sheet of conductive material that is cut or stamped, with the winding sections 208 bent out of the plane of the sheet of material.

As shown in FIG. 10, magnetic cores 102 are assembled to the terminal portion assembly 200, with one magnetic core 102 situated between each pair of terminal portions 202 and the winding sections 208 nestled in the recesses 122, 124 in the respective end edges 106, 108 of each magnetic core 102. The terminal portion assembly 200 ensures a proper position and orientation of the terminal portions 122 and facilitates assembly of the cores 102 with relative ease. The recesses 118, 120, 122, 124 of the cores 102 facilitate assembly by effectively functioning as guide surfaces for assembly with the terminal portions 202.

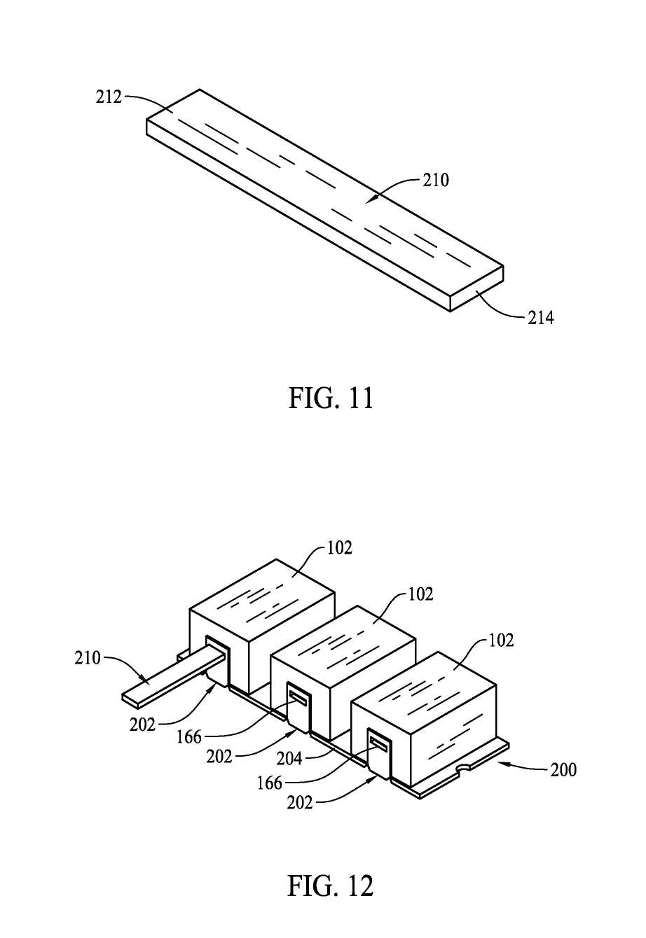

FIG. 11 shows an exemplary main winding section 210 that may be assembled to the cores 102 and terminal portions 202 in FIG. 10. The main winding section 210 in the example shown is an elongated, generally flat and planar conductive element having a rectangular cross section. The main winding portion has a first end 212, a second end 214 opposing the first end 212, and extends lineally in between the first and second ends 212 having a uniform or constant width and thickness dimension. The width and thickness dimensions are selected to provide an increased cross section that in turn provides an acceptable DCR when used in higher current, higher power applications.

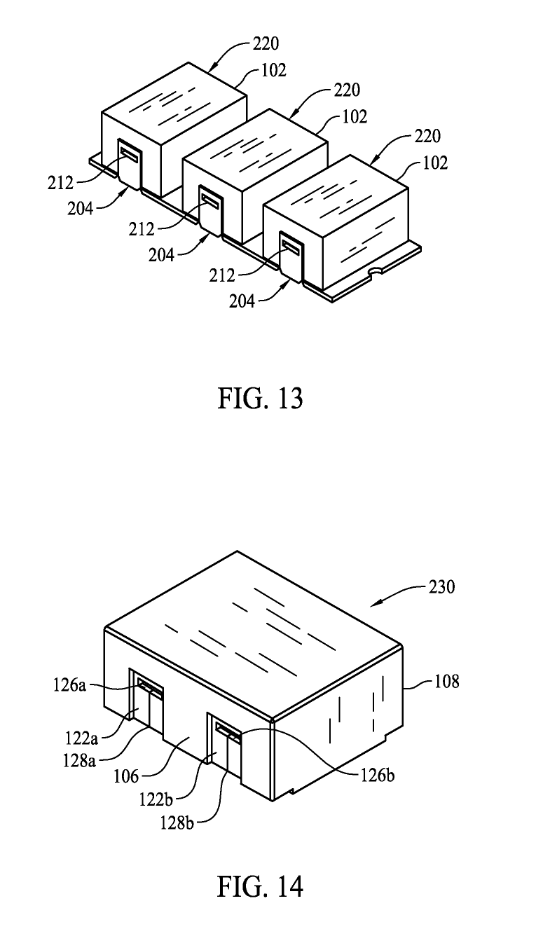

As shown in FIGS. 12 and 13, the main winding portion 210 is extended through each opening 210 in the main winding section 208 and through the through-hole 126 (FIGS. 2 and 3) in each magnetic core 102. The ends 212, 214 of the main winding portion 210 may then be mechanically and electrically connected to the winding sections 210 of the terminal portions 202 with soldering or welding techniques, for example. When the mechanical and electrical connections are complete, discrete power inductor components 220 are completed. The components 220 may be singulated from the lead frame 204 using known trimming techniques, or could be mounted to a circuit board as an array with the lead frame 204 intact. The power inductors 220 provide similar benefits and advantages to the power inductor component 100 described above, with a slightly easier manufacture.

FIG. 14 illustrates a magnetic core 230 for a third exemplary embodiment of a power inductor for a circuit board application. The magnetic core 230 is similar to the core 102 described above but includes two recesses 122a, 122b in the first end edge 106 and corresponding recesses 124a, 124b (not visible in FIG. 14) in the end edge 108. Physical gaps 128a, 128b are likewise formed and communicate with through-hole openings 126a, 126b. As such, the core 230 is similar to the core 102 but is configured to accommodate two conductive windings instead of one.

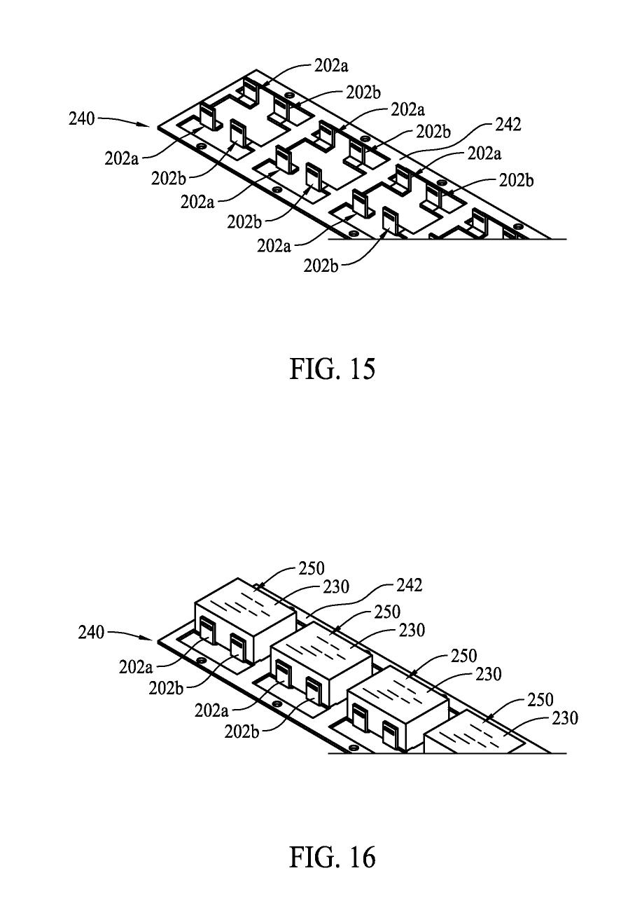

FIG. 15 illustrates a terminal portion assembly 240 having a series of pairs of terminal portions 202a, 202b coupled to a terminal frame 242. FIG. 16 shows a series of magnetic cores 230 assembled to the terminal portion assembly 240 in between the terminal portions 202a, 202b. Main wining portions 210 may then be installed as shown in FIG. 16 and as described above to complete a number of power inductors 250 each having two conductive windings defined by the terminal portions 202a, 202b and the interconnecting main winding portions 210. The lead frame 242 may be trimmed to singulate the power inductors 250 into discrete power inductors that may be separately mounted to a circuit board. The two conductive windings in the power inductors 250 is ideal for a two phase power management applications on a circuit board, but the power inductor 250 otherwise offers similar benefits and advantages as the power inductor 100 and 220 described above.

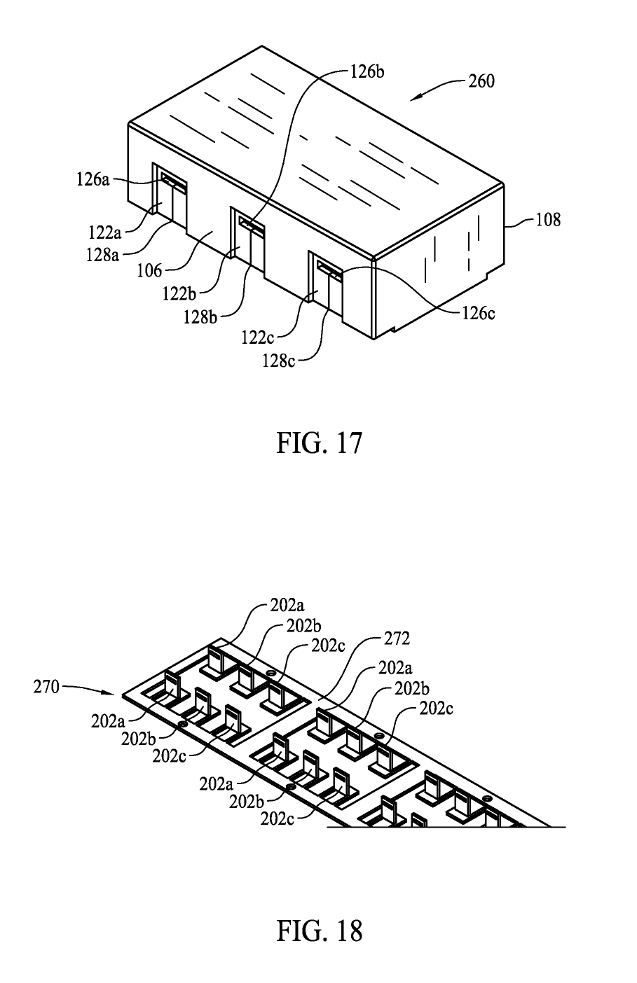

FIG. 17 illustrates a magnetic core 260 for a fourth exemplary embodiment of a surface mount power inductor for a circuit board application. The magnetic core 260 is similar to the core 230 described above but includes three recesses 122a, 122b, 126c in the first end edge 106 and corresponding recesses 124a, 124b, 124c (not visible in FIG. 17) in the end edge 108. Physical gaps 128a, 128b, 128c are likewise formed and communicate with through-hole openings 126a, 126b, 126c. As such, the core 260 is similar to the core 230 but is configured to accommodate three conductive windings instead of two,

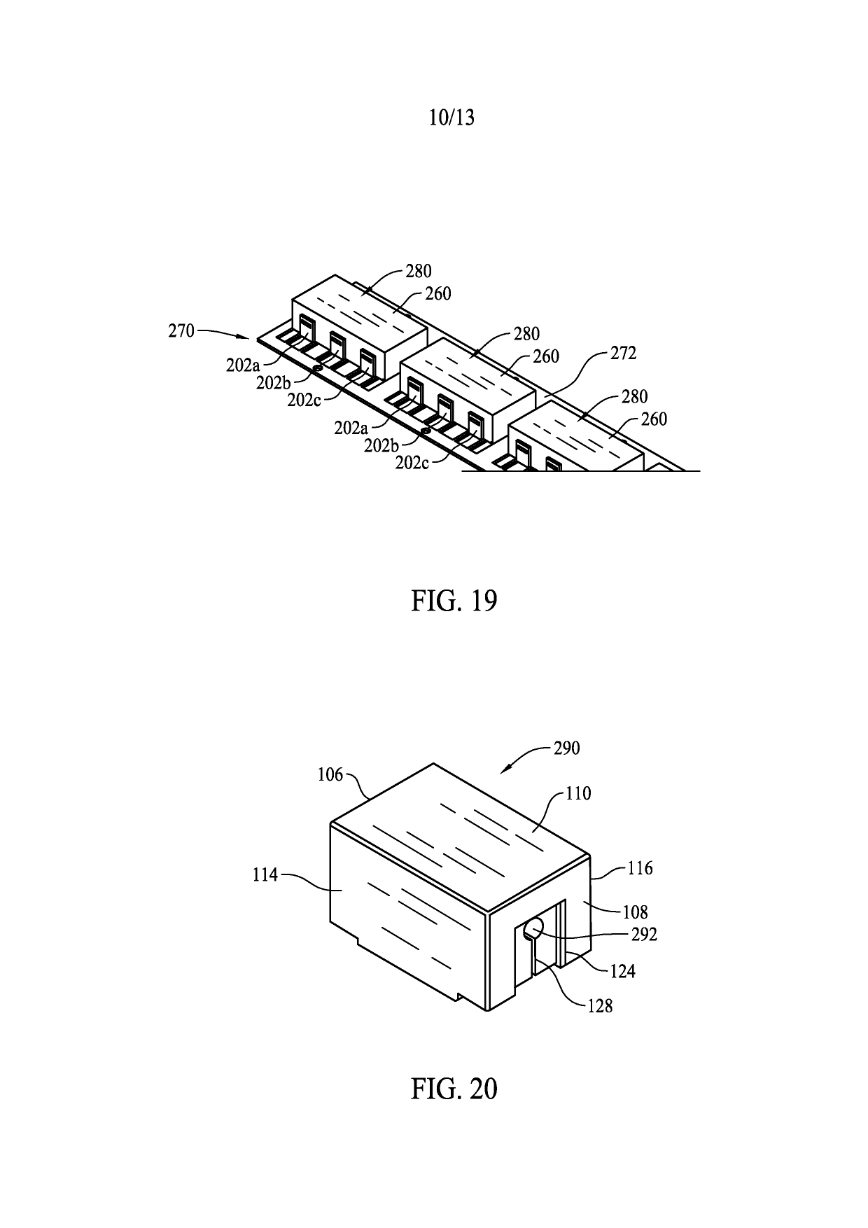

FIG. 18 illustrates a terminal portion assembly 270 having a series of pairs of terminal portions 202a, 202b, 202c coupled to a terminal frame 272. FIG. 19 shows a series of magnetic cores 270 assembled to the terminal portion assembly 240 in between the terminal portions 202a, 202b, 202c. Main wining portions 210 may then be installed as shown in FIG. 16 and as described above to complete a number of power inductors 280 each having three conductive windings defined by the terminal portions 202a, 202b, 202c and the interconnecting main winding portions 210. The lead frame 272 may be trimmed to singulate the power inductors 280 into discrete power inductors that may be separately mounted to a circuit board. The three conductive windings in the power inductors 280 is ideal for a three phase power management applications on a circuit board, but the power inductor 180 otherwise offers similar benefits and advantages as the power inductors 100, 220 and 260 described above.

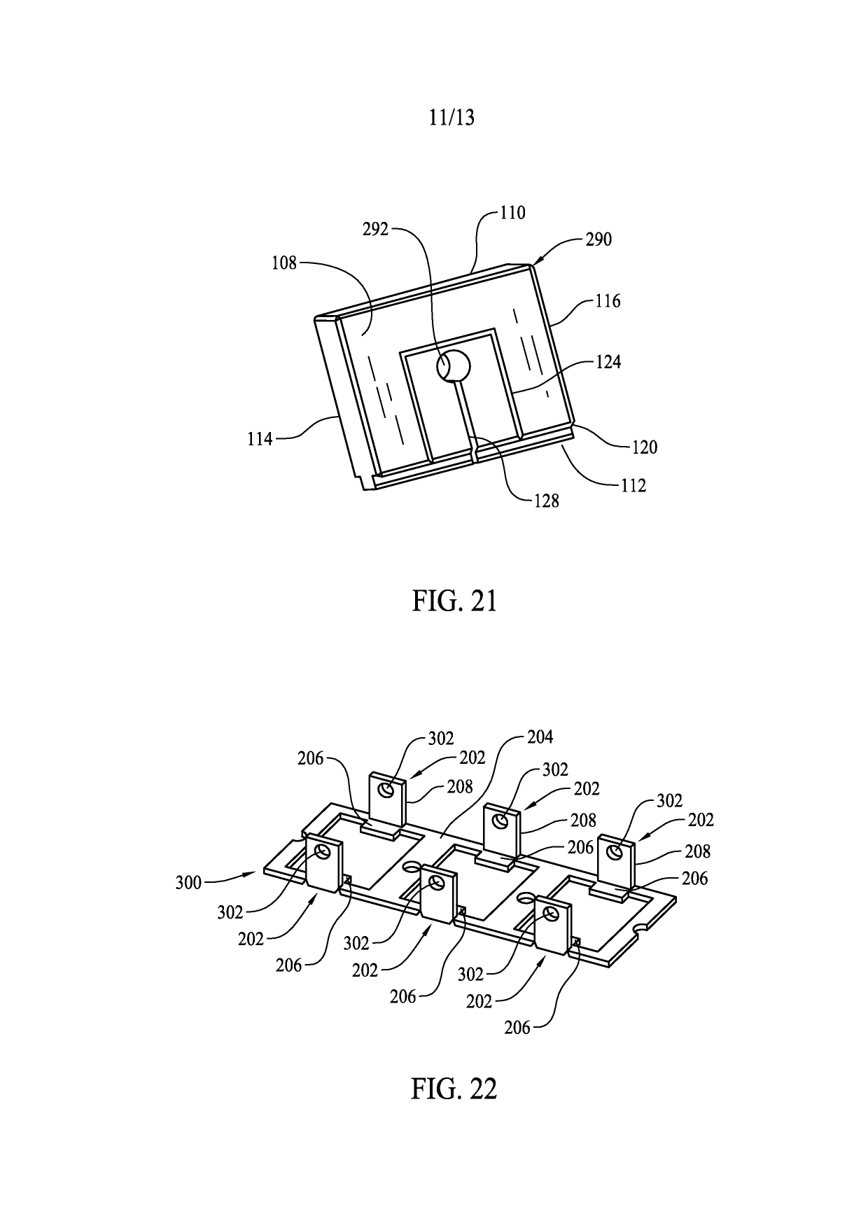

FIGS. 20 and 21 illustrate a magnetic core 290 for a fifth exemplary embodiment of a power inductor. The core 290 is similar to the core 102 described above except that the core 290 has a through-hole opening 292 with a round cross section in lieu of the through-hole opening 126 having the rectangular cross section described above.

FIG. 22 illustrates a preformed terminal portion assembly 300 that may be used to fabricate inductors according to the fifth embodiment. The assembly 300 includes a series of pairs of terminal portions 202 arranged in opposing pairs and coupled to a lead frame 204. Each terminal portion 202 includes a preformed surface mount pad 206 and winding section 208 extending perpendicular to the surface mount pad 206 and out of the plane of the terminal lead frame 204. The winding sections 208 are each formed with a round opening 302. The terminal portion assembly 300 may be fabricated from known electrically conductive materials or alloys known in the art, and may be fabricated from a single sheet of conductive material that is cut or stamped, with the winding sections 208 bent out of the plane of the sheet of material.

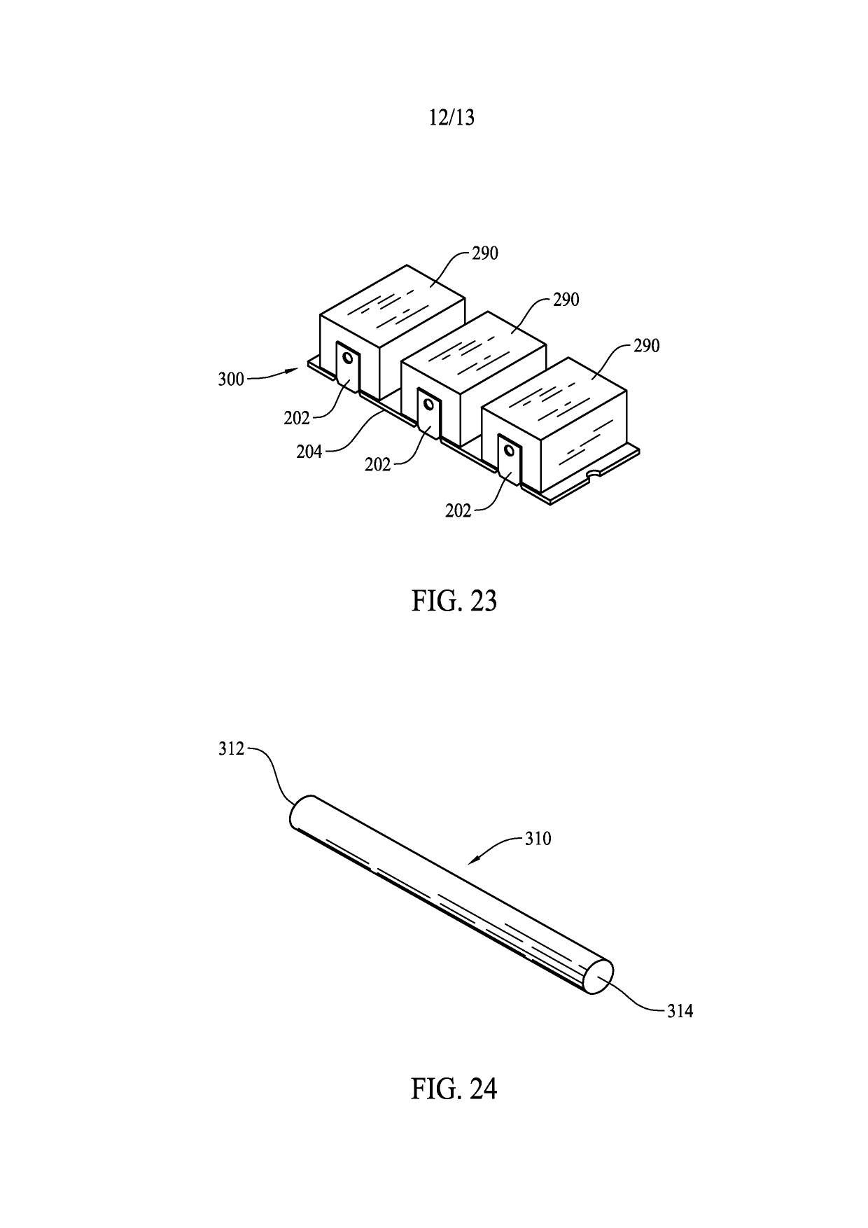

As shown in FIG. 23, magnetic cores 290 are assembled to the terminal portion assembly 200, with one magnetic core 290 situated between each pair of terminal portions 202 and the winding sections 208 nestled in the recesses 122, 124 in the respective end edges 106, 108 of each magnetic core 290.

FIG. 24 shows an exemplary main winding section 310 that may be assembled with the assembly shown in FIG. 23. The main winding section 310 in the example shown is an elongated, generally cylindrical conductive element having a circular cross section. The main winding portion 310 has a first end 312, a second end 314 opposing the first end 312, and extends lineally in between the first and second ends 312, 314 having a uniform or constant width and thickness dimension along its axial length. The diameter of the main winding section 310 is selected to provide a desired cross sectional area that in turn provides an acceptable DCR when used in higher current, higher power applications.

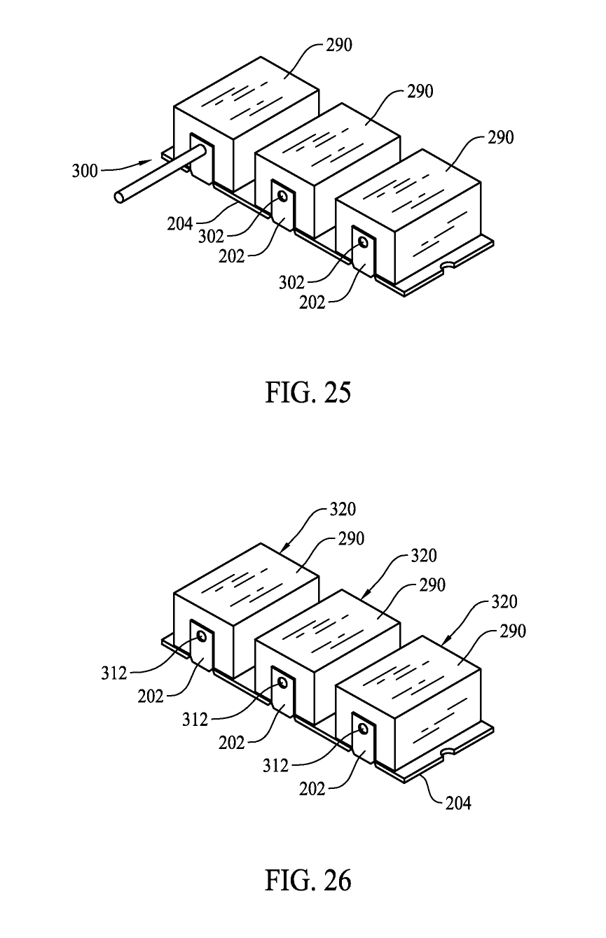

As shown in FIGS. 25 and 26, the main winding portion 310 is extended through each opening 302 in the winding section 208 and through the through-hole 292 (FIGS. 20 and 21) in each magnetic core 290. The ends 312, 314 of the main winding portion 310 may then be mechanically and electrically connected to the winding sections 208 of the terminal portions 202 with soldering or welding techniques, for example. When the mechanical and electrical connections are complete, discrete power inductor components 320 are completed. The components 320 may be singulated from the lead frame 204 using known trimming techniques to provide discrete power inductors 320 that may be separately mounted to a circuit board. The power inductors 320 provide similar benefits and advantages to the power inductor component 100 described above.

While the power inductors 320 include one conductive winding each, it is understood that more than one winding could be provided using the techniques described above. For that matter, any of the power inductors described above could be fabricated to include any number n of conductive windings desired.

The benefits and advantages of the invention are now believed to be evident in view of the exemplary embodiments disclosed.

An embodiment of an electromagnetic component assembly has been disclosed including: a magnetic core having opposed first and second end edges; and at least one preformed conductive winding separately fabricated from the magnetic body. The at least one preformed conductive winding includes: a first preformed terminal portion, a second preformed terminal portion, and a preformed main winding portion extending between the first and second terminal portions, wherein the main winding portion is fabricated from a freestanding conductor element having a first end, a second end, and a straight section extending entirely from the first end to the second end. The first terminal portion and the second terminal portion respectively extend from the first end edge and the second end edge of the magnetic core, and each of the first terminal portion and the second terminal portion include a straight section extending perpendicularly to the straight section of the main winding portion. At least one of the first terminal portion and the second terminal portion is separately fabricated from the main winding portion and is mechanically and electrically connected to the main winding portion at one of the opposed end edges of the magnetic core.

Optionally, each of the first terminal portion and the second terminal portion may be separately fabricated from the main winding portion. The first terminal portion and the second terminal portion each have a preformed surface mount terminal pad extending parallel to the straight section of the main winding portion. The magnetic core further includes a bottom surface interconnecting the opposed first and second end edges, and the surface mount terminal pad extends parallel to the bottom surface. The bottom surface of the magnetic core may be formed with a recess extending adjacent each of the opposed first and second end edges, and the surface mount terminal pad of each of the first and second terminal portions extends in a respective one of the recesses. The first terminal portion may be formed integrally with the main winding portion.

The main winding portion may have a rectangular cross section. The main winding portion may have a circular cross section. The magnetic core may be formed with a conductor through-hole opening extending between the opposed end edges, and the main winding portion is extended through the conductor through-hole opening. The magnetic core may be formed with a physical gap extending between the opposed end edges of the core. The physical gap may extend perpendicular to the main winding portion. At least one of the opposed end edges of the magnetic core may be formed with a recess, and at a least a portion of one of the first terminal portion and the second terminal portion is positioned in the recess. At least one of the first terminal portion and the second terminal portion may be formed with an opening, and a portion of the main winding portion is received in the opening. The opening may be rectangular, or the opening may be round. One of the first end and second end of the main winding portion may be tapered. The main winding portion may have a first width dimension and at least one of the first terminal portion and the second terminal portion may have a second width dimension that is different from the first width dimension. The first width dimension may be less than the second width dimension. The at least one preformed conductive winding may include a plurality of preformed conductive windings.

Another embodiment of an electromagnetic component assembly has been disclosed including: a magnetic core having opposed end edges, a through-hole extending between the opposed end edges, and a bottom surface; and at least one preformed conductive winding separately fabricated from the magnetic body. The at least one preformed conductive winding includes: a first terminal portion comprising a preformed planar surface mount terminal pad and a winding section extending perpendicular to the surface mount terminal pad, and a lineally extending main winding portion separately fabricated from the first terminal portion, the main winding portion extending through the through-hole in the magnetic core. The first terminal portion and the main winding portion are mechanically and electrically connected to one another at one of the end edges of the magnetic body, and the winding section of the first terminal portion extends adjacent one of the opposed end edges of the magnetic core. The first planar surface mount pad extends adjacent the bottom surface of the magnetic core.

Optionally, the electromagnetic component assembly may further include a second terminal portion having a surface mount terminal pad. The second terminal portion is integrally formed with the main winding portion. The winding section of the first terminal portion may include an opening, and an end of the main winding section may be received in the opening. The opening may be one of a round opening and a rectangular opening. The end of the main winding section may be tapered, and the opening receives the tapered end. The through-hole of the magnetic core may have one of a round cross section and a rectangular cross section. The magnetic body may be formed with a physical gap. The physical gap may extend perpendicularly to the bottom surface. The at least one preformed conductive winding may include a plurality of preformed conductive windings. The assembly may define a power inductor.

Another embodiment of an electromagnetic component assembly has been disclosed. The assembly includes: a magnetic core having opposed end edges, a through-hole extending between the opposed end edges, a bottom surface and a physical gap extending perpendicularly to the bottom surface; and at least one preformed conductive winding separately fabricated from the magnetic body. The at least one preformed conductive winding includes: a first terminal portion and second terminal portion spaced from one another on the respective end edges of the magnetic core, the first terminal portion and the second terminal portion each comprising a preformed planar surface mount terminal pad and a winding section extending perpendicular to the surface mount terminal pad, and a lineally extending main winding portion separately fabricated from at least one of the first terminal portion and the second terminal portion, the main winding portion extending through the through-hole in the magnetic core. At least one of the first terminal portion and the second terminal portion are mechanically and electrically connected to one another at one of the end edges of the magnetic body. Each respective one of the winding section of the first terminal portion and the second terminal portion extends adjacent one of the opposed end edges of the magnetic core. Each respective one of the surface mount pads of the first and second terminal portion extends adjacent the bottom surface of the magnetic core, and the assembly defines a power inductor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electromagnetic component assembly comprising:
a magnetic core having opposed first and second end edges; and
at least one preformed conductive winding separately fabricated from the magnetic body, the at least one preformed conductive winding comprising:
a first preformed terminal portion, a second preformed terminal portion, and a preformed main winding portion extending between the first and second terminal portions,
wherein the main winding portion is fabricated from a freestanding conductor element having a first end, a second end, and a straight section extending entirely from the first end to the second end;
wherein the first terminal portion and the second terminal portion respectively extend from the first end edge and the second end edge of the magnetic core, and each of the first terminal portion and the second terminal portion include a straight section extending perpendicularly to the straight section of the main winding portion;
wherein at least one of the first terminal portion and the second terminal portion is separately fabricated from the main winding portion and is mechanically and electrically connected to the main winding portion at one of the opposed end edges of the magnetic core.

2. The electromagnetic component assembly of claim 1, wherein each of the first terminal portion and the second terminal portion are separately fabricated from the main winding portion.

3. The electromagnetic component assembly of claim 1, wherein the first terminal portion and the second terminal portion each have a preformed surface mount terminal pad extending parallel to the straight section of the main winding portion.

4. The electromagnetic component assembly of claim 3, wherein the magnetic core further comprises a bottom surface interconnecting the opposed first and second end edges, and the surface mount terminal pad extends parallel to the bottom surface.

5. The electromagnetic component assembly of claim 4, wherein the bottom surface of the magnetic core is formed with a recess extending adjacent each of the opposed first and second end edges, and the surface mount terminal pad of each of the first and second terminal portions extends in a respective one of the recesses.

6. The electromagnetic component assembly of claim 1, wherein the first terminal portion is formed integrally with the main winding portion.

7. The electromagnetic component assembly of claim 1, wherein the main winding portion has a rectangular cross section.

8. The electromagnetic component assembly of claim 1, wherein the main winding portion has a circular cross section.

9. The electromagnetic component assembly of claim 1, wherein the magnetic core is formed with a conductor through-hole opening extending between the opposed end edges, and the main winding portion is extended through the conductor through-hole opening.

10. The electromagnetic component assembly of claim 1, wherein the magnetic core is formed with a physical gap extending between the opposed end edges of the core.

11. The electromagnetic component assembly of claim 10, wherein the physical gap extends perpendicular to the main winding portion.

12. The electromagnetic component assembly of claim 1, wherein at least one of the opposed end edges of the magnetic core is formed with a recess, and at a least a portion of one of the first terminal portion and the second terminal portion is positioned in the recess.

13. The electromagnetic component assembly of claim 1, wherein at least one of the first terminal portion and the second terminal portion is formed with an opening, and a portion of the main winding portion is received in the opening.

14. The electromagnetic component assembly of claim 13, wherein the opening is rectangular.

15. The electromagnetic component assembly of claim 13, wherein the opening is round.

16. The electromagnetic component assembly of claim 1, wherein one of the first end and second end of the main winding portion is tapered.

17. The electromagnetic component assembly of claim 1, wherein the main winding portion has a first width dimension and at least one of the first terminal portion and the second terminal portion has a second width dimension that is different from the first width dimension.

18. The electromagnetic component assembly of claim 1, wherein the first width dimension is less than the second width dimension.

19. The electromagnetic component assembly of claim 1, wherein the at least one preformed conductive winding comprises a plurality of preformed conductive windings.

20. An electromagnetic component assembly comprising:
a magnetic core having opposed end edges, a through-hole extending between the opposed end edges, and a bottom surface; and
at least one preformed conductive winding separately fabricated from the magnetic body, the at least one preformed conductive winding comprising:
a first terminal portion comprising a preformed planar surface mount terminal pad and a winding section extending perpendicular to the surface mount terminal pad, and
a lineally extending main winding portion separately fabricated from the first terminal portion, the main winding portion extending through the through-hole in the magnetic core,
wherein the first terminal portion and the main winding portion are mechanically and electrically connected to one another at one of the end edges of the magnetic body, and
wherein the winding section of the first terminal portion extends adjacent one of the opposed end edges of the magnetic core and wherein the first planar surface mount pad extends adjacent the bottom surface of the magnetic core.

21. The electromagnetic component assembly of claim 20, further comprising a second terminal portion having a surface mount terminal pad, the second terminal portion being integrally formed with the main winding portion.

22. The electromagnetic component assembly of claim 20, wherein the winding section of the first terminal portion comprises an opening, and an end of the main winding section is received in the opening.

23. The electromagnetic component assembly of claim 22, wherein the opening comprises one of a round opening and a rectangular opening.

24. The electromagnetic component assembly of claim 22, wherein the end of the main winding section is tapered, and the opening receives the tapered end.

25. The electromagnetic component assembly of claim 20, wherein the through-hole of the magnetic core has one of a round cross section and a rectangular cross section.

26. The electromagnetic component assembly of claim 20, wherein the magnetic body is formed with a physical gap.

27. The electromagnetic component assembly of claim 26, wherein the physical gap extends perpendicularly to the bottom surface.

28. The electromagnetic component assembly of claim 20, wherein the at least one preformed conductive winding comprises a plurality of preformed conductive windings.

29. The electromagnetic component assembly of claim 1, wherein the assembly defines a power inductor.

30. An electromagnetic component assembly comprising:
a magnetic core having opposed end edges, a through-hole extending between the opposed end edges, a bottom surface and a physical gap extending perpendicularly to the bottom surface; and
at least one preformed conductive winding separately fabricated from the magnetic body, the at least one preformed conductive winding comprising:
a first terminal portion and second terminal portion spaced from one another on the respective end edges of the magnetic core, the first terminal portion and the second terminal portion each comprising a preformed planar surface mount terminal pad and a winding section extending perpendicular to the surface mount terminal pad, and
a lineally extending main winding portion separately fabricated from at least one of the first terminal portion and the second terminal portion, the main winding portion extending through the through-hole in the magnetic core,
wherein at least one of the first terminal portion and the second terminal portion are mechanically and electrically connected to one another at one of the end edges of the magnetic body,
wherein each respective one of the winding section of the first terminal portion and the second terminal portion extends adjacent one of the opposed end edges of the magnetic core and wherein each respective one of the surface mount pads of the first and second terminal portion extends adjacent the bottom surface of the magnetic core, and
wherein the assembly defines a power inductor.
